(19) United States
(12) Patent Application Publication
(10) Pub. No.: US 2007/0187530 A1
(43) Pub. Date: Aug. 16, 2007

(54) Process of controlled injection of fluid into air movement systems

(76) Inventor: Virgil O. Byrd, Lanett, AL (US)

Correspondence Address: VIRGIL O. BYRD, 6848 Country Club Rd., Lanett, AL, 36863, US

(21) Appl. No.: 11/353,282

(22) Filed: Feb. 13, 2006

(51) Int. Cl. A24F 25/00; B05B 7/04; B05B 1/30

(52) U.S. Cl. 239/398; 239/34; 239/533.1

(57) ABSTRACT

A “process” of controlled injection (frequency, volume and duration) of fluid mist into the selected air handling system for the purpose of distribution of fragrances, fluids for enhanced breathing, antibacterial fluids and other similar uses. The “process” can utilize existing air handler systems, can be incorporated into the initial design of new air systems and can be used in homes, commercial and industrial buildings, motor homes/travel trailers, cars, trucks, SUV's or similar applications. System designs are as described in the “Specification”, drawings and as included in the claims.

### CROSS REFERENCES

There are no cross-references applicable.

### FEDERAL SPONSORSHIP

This patent is not federally sponsored.

### JOINT RESEARCH

There is no joint research associated with this patent.

### SEQUENCE LISTING

No references listed.

### BACKGROUND OF THE INVENTION

1. Description

The process of controlled injection of fluid mists, either under direct pressure through orifices or air pressurized atomization through orifices, into air handling systems, air circulation systems, and other air movement or air delivery systems, for the purpose of deodorizing, antibacterial fluids, breathing enhancing fluids, seasonal scents, scents to enhance product sales and similar uses.

2. Purpose

To provide both centralized and individual air moving systems with injection of fluid mists. These system uses include but are not limited to—central heat and air systems, individual air conditioners and/or heat pumps, air circulation systems, etc. and for uses in but not limited to homes, commercial and industrial buildings and motor vehicles (including—motor homes, campers, automobiles, trucks, SUV's, etc.).

3. System Operation

The techniques to accomplish this process are included within the detailed description of the invention, claims and drawings form a part of this specification. The elements of these systems can be incorporated into the design of individual systems and are considered a part of the process defined herein.

### BRIEF SUMMARY OF THE INVENTION

The present invention encompasses different techniques as specified in FIGS. 1 through 4 and generally provides a “process” of injection of selected fluids into the air stream of air handling systems, such as is used in a central heat/air condition system, and for multiple purposes such as deodorizing a home, building, vehicle, etc. The “process” achieves a more complete and consistent distribution of a fragrance, as an example, than does a canister in a single room, scented candles, or similar fragrance enhancers. Other uses of the “process” add to its value such as the use of antibacterial fluids for hospitals, doctor's offices, etc.

### BRIEF DESCRIPTION OF THE DRAWINGS

FIG. 1 is a schematic drawing of Process One, which injects a fluid mist into the air chamber by means of a reservoir, a pump and tank with pressure switch and a programmable control valve to control frequency and duration of the injection. Power is provided to the programmable control valve to release the fluid into the air chamber, only when the blower is under power. The valve will remain open for the duration set and will close. The cycle will start over again as programmed and remain to cycle as long as power is supplied from the blower circuit. When the pump is powered up, it pulls fluid from the reservoir and fills and pressurizes the tank. When the programmable control valve senses the blower is under power; the valve is activated and provides fluid to the mist head where it is released as a mist into the air chamber.

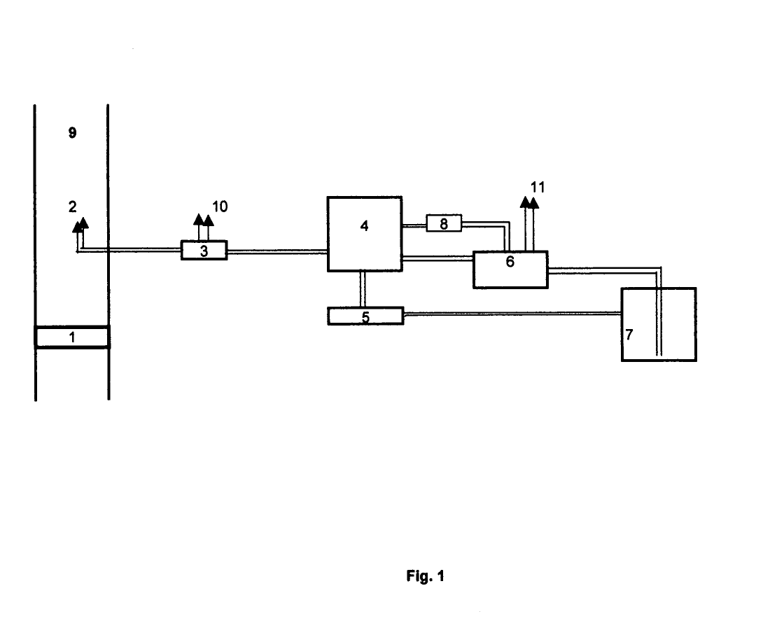

FIG. 2 is a schematic drawing of Process Two, which utilizes an air supply, a programmable control valve to control frequency and duration of injection and a mist unit with a reservoir and a mist head. Power is provided to the programmable control valve only when the blower is under power to assure air movement during injection of the mist. The system operates by the air supply providing air to the programmable control valve and when programmed to do so, releases air to the mist unit. The valve will remain open as long as set and will then close. The cycle will start over as programmed as long as power is supplied. The mist unit has a reservoir and pulls fluid from the reservoir, mixes it with air from the supply and provides the mixture to the mist head, which releases it into the air chamber.

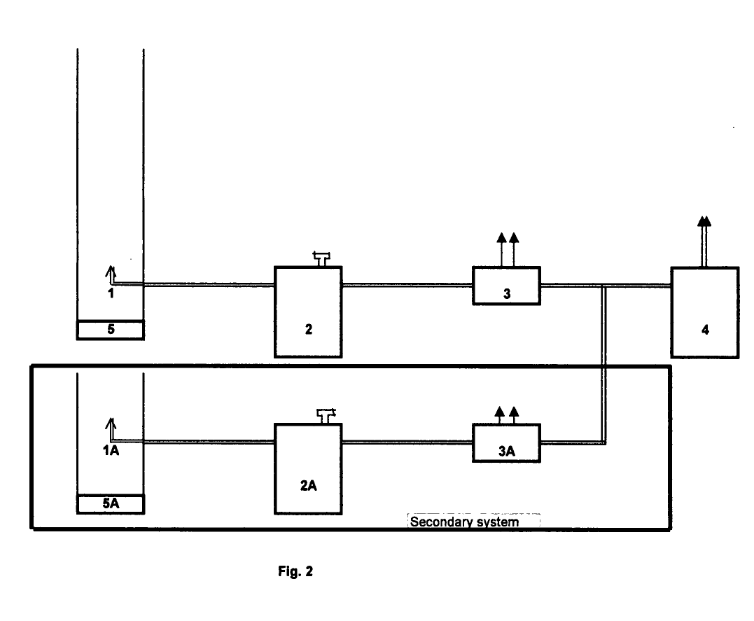

FIG. 3 is a schematic drawing of Process Three, which uses a programmable control unit to supply power to a pressurized canister unit. When the control unit senses the blower is under power, the canister is activated and injects the selected mist product into the air stream. The amount of mist sprayed is controlled by the selection of the settings in the pressurized canister unit.

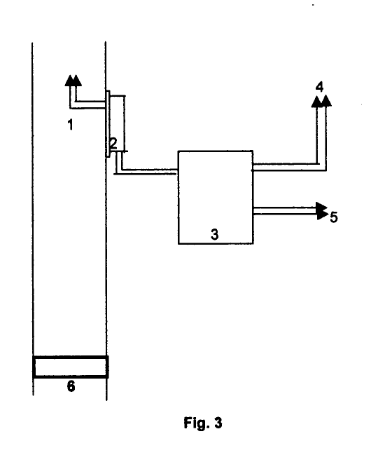

FIG. 4 is a schematic drawing of Process Four, which uses a direct pressure pump to supply fluid pressure to the programmable control valve. The control unit delays the opening of the programmable valve until line pressure is adequate to create a mist at the mist head. Power is supplied at point 6 only when the blower is under power to assure the mist is sprayed only when there is air movement in the air chamber. The programmable control valve stays open as set and will then close. The cycle will start over again as programmed as long as the blower motor is powered up.

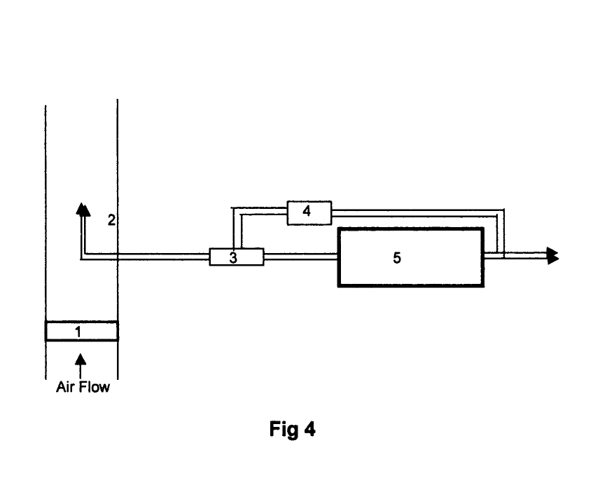

### DETAILED DESCRIPTION OF THE INVENTION

FIG. (1) utilizes a fluid pump (item 6) to pull fluid from a reservoir (item 7) and fills and pressurizes a tank (item 4). Tank pressure is controlled by a pressure switch (item 8) turning on and off the pump at desired pressure points. A programmable valve (item 3) is used to inject fluid under pressure to the mist head (item 2) in the air stream. The valve (item 3) can be programmed for frequency and duration of flow to the mist head (item 2). It is powered through the source for the blower motor and will only activate when the blower power is on. This prevents injection of fluids when there is no air movement. When the blower is powered up, the mist unit injects the fluid into the airflow and the mist is carried throughout the air handling system into all rooms serviced by the system. If, for example, the fluid is a fragrance, the entire area serviced by the system will have the fragrance. To change the fluid, a manual valve (item 5) is used to drain fluid from the tank back to the reservoir. With optional PLC's, the system can be programmed for hours and days of use. FIG. (2) uses a small air compressor (item 4) to pressurize an air receiver and is controlled by a pressure switch. A programmable control valve (item 3) is used to adjust the frequency and duration of the injection. The valve (item 3) is powered by the same power source as the blower motor and will only activate when the blower power is on. This prevents injection of fluid when there is no air movement. The air valve provides air to a mist unit (item 2) with a reservoir containing the desired fluid and the mist unit mixes air and fluid at the nozzle of the mist head. The mist unit can also be adjusted for pressure and volume of the fluid to be injected. The air delivery system can be sized to support separate mist units using different fluids for separate delivery systems. With optional PLC's, the system can be programmed for hours and days of use. FIG. (3) utilizes a self contained pressurized canister (item 2) mounted to inject the fluid into the air stream down stream of the system filter (item 6) and using a remote control (item 3) to activate the nozzle (item 1) on the canister. The remote control uses the power source (item 4) from the blower motor as an input signal to activate the pump unit on the canister. This prevents the canister from being activated when there is no air movement.

FIG. (4) utilizes a direct pump (item 5) with a self contained reservoir and a delay valve (item 3) to pressurize the line and release the fluid to the mist head (item 2) in the air chamber. The delay valve (item 3) allows the pressure to be released at full pressure so the fluid does not run out in droplets. Power is provided through the blower power (item 6) and prevents release while there is no air flow. The programmable valve controls time and duration of the injection.

1. I claim the process of injecting a fluid mist into the air stream of systems as defined but not limited to those identified in the specification above.

2. I claim the process will provide the utilizing system with fluid mist injection for:
a. deodorizing
b. antibacterial
c. breathing enhancers
d. seasonal scents
1. Christmas
2. Spring
3. Etc.
e. Sales enhanced fragrances for:
1. chocolate
2. roasted nuts
3. coffee
4. suntan products
5. Etc.
f. New car scents
g. Other uses

3. I claim the design of the system outlined in FIG. (1) and that the system will accomplish the proper injection of the fluids into the air stream as described in the specifications.

4. I claim the design of the system outlined in FIG. (2) and that the system will accomplish the proper injection of the fluids into the air stream as described in the specifications.

5. I claim the design of the system outlined in FIG. (3) and that the system will accomplish the proper injection of the fluids into the air stream as described in the specifications.

6. I claim the design of the system outlined in FIG. (4) and that the system will accomplish the proper injection of the fluids into the air stream as described in the specifications.

7. I claim that if the process included herein is incorporated into the initial designs of these type systems that the systems would accomplish the process defined in the specifications.
